(19) United States
(12) Patent Application Publication
(10) Pub. No.: US 2012/0168370 A1
(43) Pub. Date: Jul. 5, 2012

(54) METHOD OF IMPROVING REJECTION OF PERMEABLE MEMBRANE AND PERMEABLE MEMBRANE

(75) Inventors: Tetsuya Aoki, Shinjuku-ku (JP); Takahiro Kawakatsu, Shinjuku-ku (JP)

(73) Assignee: KURITA WATER INDUSTRIES LTD., Tokyo (JP)

(21) Appl. No.: 13/496,785

(22) PCT Filed: Sep. 27, 2010
(86) PCT No.: PCT/JP2010/066654

§ 371 Date: Mar. 16, 2012

(30) Foreign Application Priority Data
Sep. 29, 2009 (JP) 2009-224643

(51) Int. Cl. B01D 65/06; B01D 71/06

(52) U.S. Cl. 210/500.27; 134/22.19

(57) ABSTRACT

Provided is a method capable of effectively improving the rejection of a membrane without considerably lowering the permeation flux, even when the membrane has significantly degraded. The method of improving the rejection of a permeable membrane includes a step (amino treatment step) of passing an aqueous solution (amino treatment water) having a pH of 7 or less and containing an amino group-containing compound having a molecular weight of 1000 or less through the permeable membrane. After this amino treatment step, water having a higher pH than the amino treatment water is allowed to pass through the permeable membrane. Thus, by allowing the low-molecular-weight amino compound to pass through the membrane, a degraded portion of the membrane can be restored without considerably lowering the permeation flux of this permeable membrane, and the rejection can be effectively improved.

### FIELD OF INVENTION

The present invention relates to a method of improving a rejection of a permeable membrane, more specifically, relates to a method of restoring a permeable membrane, in particular, a degraded reverse osmosis (RO) membrane to effectively improve the rejection of the membrane without considerably reducing the permeation flux of the permeable membrane. The present invention also relates to a permeable membrane treated for improving the rejection by the method of improving the rejection of a permeable membrane, a water-treating method using this permeable membrane, a permeable membrane device, and a water-treating apparatus.

### BACKGROUND OF INVENTION

In recent years, in order to effectively use water resources, processes for collecting, recycling, and reusing wastewater and processes for desalting seawater and brine have been progressively introduced. In order to obtain treated wastewater with high quality, selective permeable membranes, such as nano filtration membranes and reverse osmosis membranes (RO membranes) capable of removing electrolytes or low- to middle-molecular-weight molecules, have been used.

The rejection of a permeable membrane such as an RO membrane for a separation target such as an inorganic electrolyte or a water-soluble organic substance is decreased by degradation of a polymer material of the membrane due to influences of an oxidizing material or a reducing material in water or other factors, resulting in an insufficient treated water quality. This degradation may gradually progress with use for a long time or may suddenly occur by an accident. Furthermore, in some permeable membranes, the rejections themselves as products do not satisfy a requirement.

In a permeable membrane system such as an RO membrane, raw water may be treated with chlorine (such as sodium hypochlorite) in a pretreatment process for preventing biofouling due to slime on the membrane surface. It is known that since chlorine has a strong oxidative effect, a permeable membrane is degraded by feeding raw water, without sufficiently reducing the remaining chlorine, to the permeable membrane.

In order to decompose the remaining chlorine, addition of a reducing agent such as sodium bisulfite is conducted in some cases. However, even under a reduced environment due to an excess amount of sodium bisulfite, a presence of a metal such as Cu or Co causes degradation of the membrane (Patent Document 1).

Degradation of a membrane greatly impairs the rejection of the permeable membrane. As methods of improving the rejection of a permeable membrane such as an RO membrane, for example, the following methods are conventionally proposed.

i) A method of improving the rejection of a permeable membrane by attaching an anionic or cationic polymer compound to the membrane surface (Patent Document 2).

This method achieves a certain degree of improvement of rejection, but the improvement in rejection of a degraded membrane is not sufficient.

ii) A method of improving the rejection of a nano filter membrane or an RO membrane by attaching a compound having a polyalkylene glycol chain to the membrane surface (Patent Document 3).

This method can achieve an improvement in rejection, but does not sufficiently satisfy the requirement of improving the rejection without considerably reducing the permeation flux of a degraded membrane.

iii) A method of preventing a membrane from being contaminated or the quality of permeated water from worsening by treating a nano filter membrane or an RO membrane having an increased permeation flux and anionic charge with a nonionic surfactant to reduce the permeation flux to an appropriate range (Patent Document 4). In this method, the nonionic surfactant is brought into contact with the membrane surface and is attached thereto so that the permeation flux is in a range of ±20% of that at the start of use.

The effectiveness of the improvement in rejection by this method iii) can be confirmed by comparison of Example and Comparative Example described in Patent Document 4. However, in a significantly degraded membrane (salt rejection: 95% or less), it is necessary to attach a large amount of a surfactant to the membrane surface, which is thought to cause a dramatic decrease in permeation flux. In Example of Patent Document 4, an aromatic polyamide RO membrane having a permeation flux of 1.20 m³/m²·day, a NaCl rejection of 99.7%, and a silica rejection of 99.5% as the initial performance at the time manufactured was used for 2 years and was then used as an oxidation-degraded membrane, and there is a description that the performance of the degraded membrane was increased to a permeation flux of 1.84 m³/m²·day after treatment. However, the target of the treatment is a membrane not largely degraded so as to have a NaC rejection of 99.5% and a silica rejection of 98.0%, and it is unclear whether this method can sufficiently improve the rejection of a degraded permeable membrane.

iv) A method of improving salt rejection by attaching, for example, tannic acid to a degraded membrane.

The effect of improving the rejection by this method is not high. For example, the electric conductivity of permeated water through a degraded RO membrane, ES20 (manufactured by Nitto Denko Corporation) or SUL-G20F (manufactured by Toray Industries, Inc.), was improved from 82% to 88% or from 92% to 94%, respectively, and this method cannot raise the rejection to a level capable of reducing the solute concentration in permeated water to ½.

Incidentally, regarding the degradation of permeable membrane, it is known that, for example, in degradation of a polyamide membrane by an oxidizing agent, the C—N bond of a polyamide bond in the membrane material is broken to collapse the original sieve structure of the membrane.

### PATENT DOCUMENTS

Patent Document 1: Japanese Patent Publication 7-308671
Patent Document 2: Japanese Patent Publication 2006-110520
Patent Document 3: Japanese Patent Publication 2007-289922
Patent Document 4: Japanese Patent Publication 2008-86945

As described above, various methods improving rejection of a permeable membrane have been conventionally proposed, but since additional substance is attached to a permeable membrane surface in such conventional methods of improving rejection, a reduction in permeation flux occurs. For example, in order to reduce the solute concentration in permeated water to ½ by recovering the rejection, the permeation flux has been reduced by 20% or more with respect to that before the treatment in some cases. In addition, in existing technologies, it was difficult to recover the rejection of a membrane that has been significantly degraded (for example, the electric conductance rejection was reduced to 95% or less).

### OBJECT AND SUMMARY OF INVENTION

### Object of Invention

It is an object of the present invention to solve the above-described conventional problems and to provide a method that can effectively improve a rejection of a membrane, even if the membrane is significantly degraded, without considerably reducing the permeation flux. It is also an object of the present invention to provide a rejection-improved permeable membrane by the method of improving the rejection of a permeable membrane, a water-treating method using the permeable membrane, a permeable membrane device having the permeable membrane, and a water-treating apparatus.

### SUMMARY OF INVENTION

An aspect 1 provides a method of improving the rejection of a permeable membrane, wherein the method includes a step of passing an aqueous solution having a pH of 7 or less and containing an amino group-containing compound having a molecular weight of 1000 or less (hereinafter, this aqueous solution is referred to as “amino treatment water”) through the permeable membrane (hereinafter, this step is referred to as “amino treatment step”).

An aspect 2 provides the method of improving the rejection of a permeable membrane according to the aspect 1, wherein the method further includes, after the amino treatment step, a step of passing water having a higher pH than the amino treatment water through the permeable membrane (hereinafter, this step is referred to as “alkali treatment step”).

An aspect 3 provides the method of improving the rejection of a permeable membrane according to the aspect 2, wherein the water of a higher pH contains an amino group-containing compound having a molecular weight of 1000 or less.

An aspect 4 provides the method of improving the rejection of a permeable membrane according to any one of the aspects 1 to 3, wherein an aqueous solution containing a compound having an anionic functional group is allowed to pass through the permeable membrane in the amino treatment step or after the amino treatment step.

An aspect 5 provides the method of improving the rejection of a permeable membrane according to any one of the aspects 1 to 4, wherein a compound having a nonionic functional group and/or a compound having a cationic functional group is allowed to pass through the permeable membrane in the amino treatment step or after the amino treatment step.

An aspect 6 provides the method of improving the rejection of a permeable membrane according to any one of the aspects 2 to 5, wherein the amino treatment step and the alkali treatment step are repeated twice or more.

An aspect 7 provides a permeable membrane subjected to rejection-improving treatment by the method of improving the rejection of a permeable membrane according to any one of the aspects 1 to 6.

### Advantageous Effects of Invention

The present inventors have diligently performed investigation to solve the above-described problems by, for example, repeating research and analysis of degraded membranes using real machines and, as a result, have obtained the following findings.

1) As in conventional methods, in a method of closing holes of a degraded membrane by attaching another material (for example, a compound such as a nonionic surfactant or a cationic surfactant) to the membrane, the permeation flux of the membrane is considerably decreased by hydrophobization of the membrane or adhesion of a polymer material, resulting in difficulty in securing water quantity.

2) In a permeable membrane, for example, a polyamide membrane, degradation by an oxidizing agent breaks the C—N bonds of the polyamide to collapse the original sieve structure of the membrane, and the amide groups at the degraded portion of the membrane are lost by the breaking of the amide bonds. However, a part of carboxyl groups remain.

3) The rejection can be recovered by restoring the degraded membrane by efficiently attaching/bonding an amino compound to the carboxyl groups of this degraded membrane.

In this case, a considerable decrease in permeation flux due to hydrophobization of the membrane surface or adhesion of a polymer material can be inhibited by using a low-molecular-weight compound having an amino group as an amino compound to be bound to the carboxyl group.

The present invention has been accomplished based on these findings.

According to the present invention, the degraded portion of a permeable membrane can be restored to effectively improve the rejection without considerably reducing the permeation flux of the membrane by allowing an aqueous solution (amino treatment water) having a pH of 7 or less and containing an amino group-containing compound having a molecular weight of 1000 or less (hereinafter, referred to as “low-molecular-weight amino compound”) to pass through the permeable membrane degraded by, for example, an oxidizing agent.

### BRIEF DESCRIPTION OF DRAWINGS

FIG. 1a is an explanatory drawing of a chemical structural formula illustrating a mechanism of the rejection-improving treatment according to the present invention.

FIG. 1b is an explanatory drawing of a chemical structural formula illustrating the mechanism of the rejection-improving treatment according to the present invention.

FIG. 1c is an explanatory drawing of a chemical structural formula illustrating the mechanism of the rejection-improving treatment according to the present invention.

FIG. 1d is an explanatory drawing of a chemical structural formula illustrating the mechanism of the rejection-improving treatment according to the present invention.

FIG. 1e is an explanatory drawing of a chemical structural formula illustrating the mechanism of the rejection-improving treatment according to the present invention.

FIG. 1f is an explanatory drawing of a chemical structural formula illustrating the mechanism of the rejection-improving treatment according to the present invention.

FIG. 2 is a schematic diagram illustrating a flat membrane testing device used in Examples.

FIG. 3 is a schematic diagram illustrating a 4-inch module testing device used in Examples.

### DESCRIPTION OF EMBODIMENTS

Embodiments of the present invention will be described in detail below.

### [Method of Improving the Rejection of a Permeable Membrane]

The method of improving the rejection of a permeable membrane of the present invention includes an amino treatment step of passing an aqueous solution (amino treatment water) having a pH of 7 or less and containing a low-molecular-weight amino compound having a molecular weight of 1000 or less through the permeable membrane. The present invention preferably includes, after the amino treatment step, an alkali treatment step of passing water having a higher pH than the amino treatment water through the permeable membrane. In addition, this water having a higher pH preferably contains the low-molecular-weight amino compound having a molecular weight of 1000 or less.

The method of improving the rejection of a permeable membrane of the present invention may include:

a step of passing an aqueous solution containing a compound having an anionic functional group through the permeable membrane (hereinafter, referred to as “anion treatment step”) in the amino treatment step or after the amino treatment step;

a step of passing a compound having a nonionic functional group through the permeable membrane (hereinafter, referred to as “nonion treatment step”) in the amino treatment step or after the amino treatment step; or
a step of passing a compound having a cationic functional group through the permeable membrane (hereinafter, referred to as “cation treatment step”) in the amino treatment step or after the amino treatment step.

The amino treatment step and the alkali treatment or also the anion treatment step, the nonion treatment step, and the cation treatment step may be repeated twice or more. Furthermore, these may be performed in an appropriate combination.

Furthermore, in the nonion treatment step, a polymer compound such as a polymer compound having a polyalkylene glycol chain is preferably used, and in the cation treatment step, a polymer compound such as polyvinylamidine is preferably used.

In addition, pure water washing may be optionally performed between each step by allowing pure water to pass through the permeable membrane.

Accordingly, examples of the treatment procedure in the method of improving the rejection of a permeable membrane of the present invention include the followings:

i) amino treatment step→pure water washing;

ii) amino treatment step→alkali treatment step→pure water washing;

iii) the procedure ii) is repeated twice or more, for example, in the case of repeating the procedure twice, amino treatment step→alkali treatment step→pure water washing→amino treatment step→alkali treatment step→pure water washing, and in the case of repeating three times, amino treatment step→alkali treatment step→pure water washing→amino treatment step→alkali treatment step→pure water washing→amino treatment step→alkali treatment step→pure water washing;

iv) amino treatment step→alkali treatment step→pure water washing→anion treatment step→pure water washing;

v) amino treatment step→alkali treatment step→pure water washing→nonion treatment step→pure water washing;

vi) amino treatment step→alkali treatment step→pure water washing→anion treatment step and nonion treatment step→pure water washing;

vii) amino treatment step→alkali treatment step→pure water washing→cation treatment step→pure water washing;

viii) amino treatment step→alkali treatment step→pure water washing→cation treatment step and nonion treatment step→pure water washing;

ix) in the procedures iii) to viii), amino treatment step→alkali treatment step is repeated twice, and pure water washing is performed, followed by the subsequent step;

x) in the procedures i) to vi) and ix), amino treatment and cation treatment are simultaneously performed as the amino treatment step;

xi) in the procedures i) to iv), vii), and ix), amino treatment and nonion treatment are simultaneously performed as the amino treatment step; and

xii) in the procedures i) to iv) and ix), amino treatment, cation treatment, and nonion treatment are simultaneously performed as the amino treatment step.

### [Mechanism of Membrane Restoration]

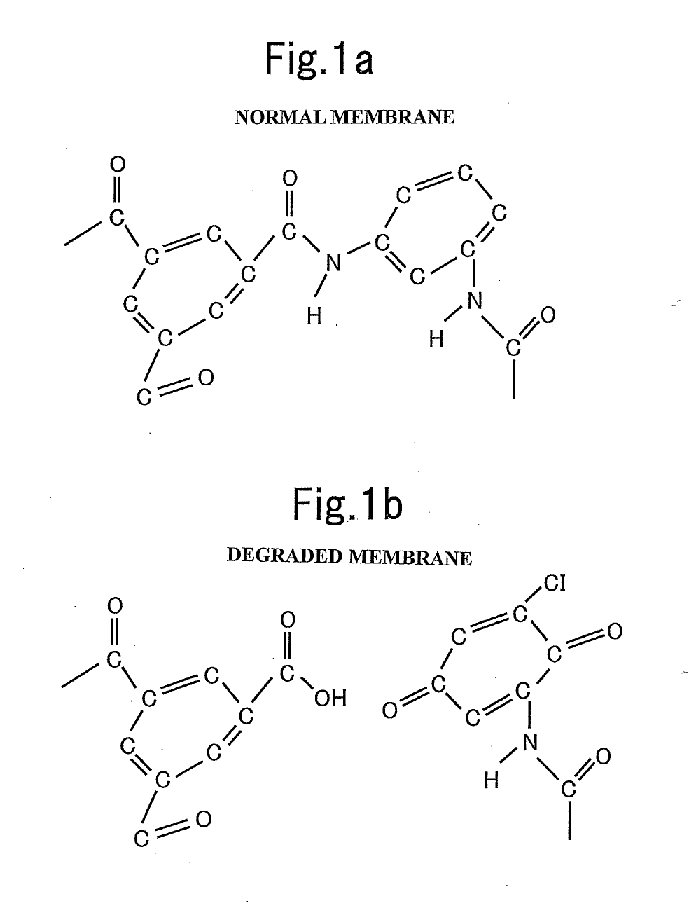

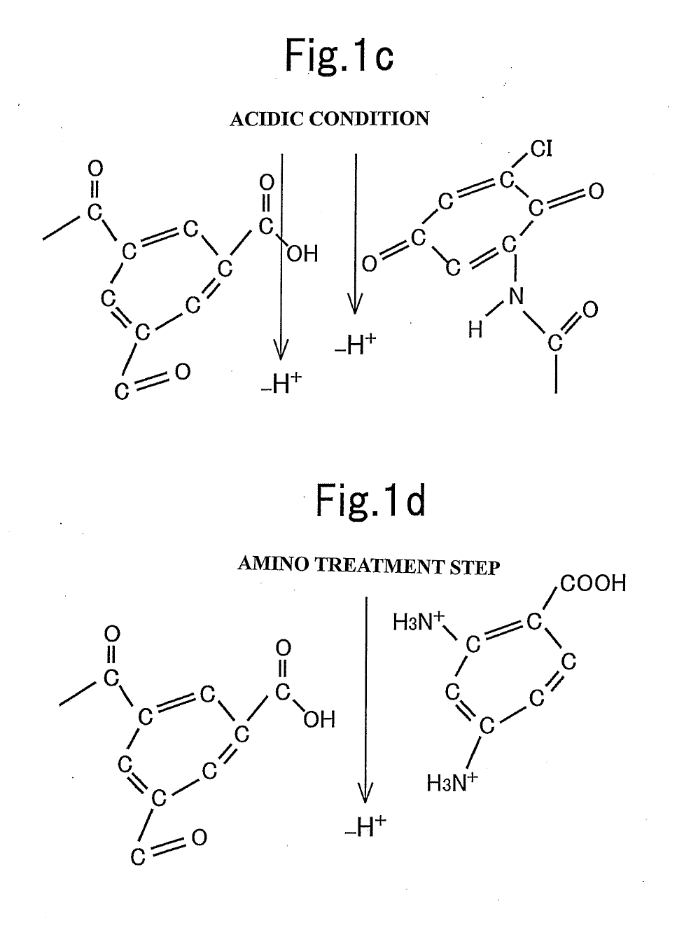

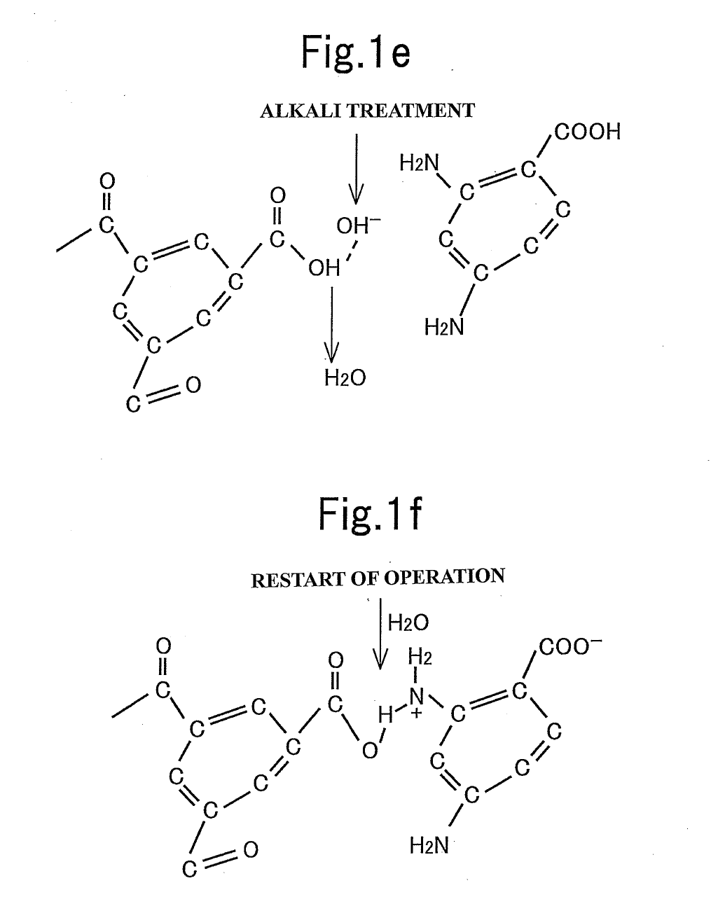

The mechanism of restoration of a degraded membrane according to the present invention is conjectured as shown in FIGS. 1a to 1f.

A normal amide bond of a permeable membrane such as a polyamide membrane has a structure as shown in FIG. 1a. If this membrane is degraded by an oxidizing agent such as chlorine, the C—N bond of the amide bond is broken, and a structure shown in FIG. 1b is eventually formed.

As shown in FIG. 1b, the amide group is lost by oxidation due to the breaking of the amide bond, and a carboxyl group is formed at this broken site.

In such a degraded membrane, the hydrogen of the carboxyl group is not dissociated under the acidic conditions where acidic water having a low pH passes through the membrane as shown in FIG. 1c, and therefore the anionic charge is weakened.

If this acidic water contains a low-molecular-weight amino compound (in FIG. 1d, 2,4-diaminobenzoic acid), since the solubility of the low-molecular-weight amino compound is high under the low pH conditions, as shown in FIG. 1d, this low-molecular-weight amino compound, as a solute, is brought into contact with degraded portion of the membrane.

In this state, as shown in FIG. 1e, the solubility of the low-molecular-weight amino compound decreases by increasing the pH using an alkali agent. Under the alkali conditions, as shown in FIG. 1f, the low-molecular-weight amino compound binds to the membrane by an electrostatic bond between the amino group and the carboxyl group of the membrane to form an insoluble salt. The hole of the degraded membrane is restored by this insoluble salt to recover the rejection.

In permeation of the low-molecular-weight amino compound through the membrane, several types of amino compounds different in molecular weight and skeleton (structure) are used together. By allowing these compounds to permeate together, the compounds obstruct each other's permeation in the membrane to remain for a longer time at the degraded portion of the membrane, resulting in an increase in probability of contact between the carboxyl group of the membrane and the amino group of the low-molecular-weight amino compound. Consequently, the efficiency of restoring the membrane is increased.

In particular, a largely degraded portion of a membrane can be closed by simultaneously using compounds having high molecular weights, resulting in an increase in restoration efficiency.

Each step will be described below.

### <Amino Treatment Step>

In the present invention, the amino compound used in the amino treatment step has an amino group and a relatively low molecular weight of 1000 or less, and examples thereof include, but not limited to, the following a) to f):

a) aromatic amino compounds: for example, those each having a benzene skeleton and an amino group, such as aniline and diaminobenzene;

b) aromatic aminocarboxylic acid compounds: for example, those each having a benzene skeleton, two or more amino groups, and a carboxyl group or carboxyl groups in such a manner that the number of the carboxyl group is smaller than that of the amino groups, such as 3,5-diaminobenzoic acid, 3,4-diaminobenzoic acid, 2,4-diaminobenzoic acid, 2,5-diaminobenzoic acid, and 2,4,6-triaminobenzoic acid;

c) aliphatic amino compounds: for example, those each having a straight-chain hydrocarbon group having about 1 to 20 carbon atoms and one or more amino groups, such as methylamine, ethylamine, octylamine, and 1,9-diaminononane (throughout the specification, may be abbreviated to “NMDA”) (C₉H₁₈(NH₂)₂), and those each having a branched hydrocarbon group having about 1 to 20 carbon atoms and one or more amino groups, such as aminopentane (NH₂(CH₂)₂CH(CH₃)₂) and 2-methyloctanediamine (throughout the specification, may be abbreviated to “MODA”) (NH₂CH₃CH(CH₃)(CH₂)₆NH₂);

d) aliphatic aminoalcohols: for example, those each having a straight-chain or branched hydrocarbon group having 1 to 20 carbon atoms, an amino group, and a hydroxyl group, such as monoaminoisopentanol (throughout the specification, may be abbreviated to “AMB”) (NH₂(CH₂)₂CH(CH₃)CH₂OH);

e) cyclic amino compounds: for example, those each having a heterocycle and an amino group, such as tetrahydrofurfurylamine (throughout the specification, may be abbreviated to “FAM”) (represented by the following structural formula)

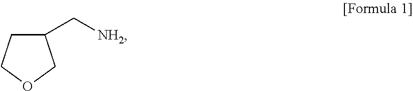

and chitosan; and f) amino acid compounds: for example, basic amino acid compounds such as arginine and lysine, amino acid compounds having an amido group such as asparagine and glutamine, other amino acid compounds such as glycine and phenylalanine, peptides as polymers thereof, and derivatives thereof such as aspartame.

These low-molecular-weight amino compounds each have high solubility to water and can be used as a stable aqueous solution that passes through a permeable membrane so that, as described above, the compound reacts with the carboxyl group of the membrane to bind to the permeable membrane, forms an insoluble salt, fills a hole generated by degradation of the membrane, and thereby increases the rejection of the membrane.

If the molecular weight of the low-molecular-weight amino compound used in the amino treatment step of the present invention is larger than 1000, the amino compound may not be capable of permeating into a fine degraded portion, and such an amino compound is therefore unfavorable. However, an amino compound having an excessively small molecular weight hardly remains in a skin layer of the membrane. Accordingly, the molecular weight of the amino compound is preferably 1000 or less, more preferably 500 or less, and most preferably 60 to 300.

These low-molecular-weight amino compounds may be used alone or as a mixture of two or more thereof. In particular, in the present invention, when two or more types of low-molecular-weight amino compounds different in molecular weight and skeleton structure are used together and are allowed to simultaneously permeate through a permeable membrane, the compounds obstruct each other's permeation in the membrane to remain for a longer time at the degraded portion of the membrane, resulting in an increase in probability of contact between the carboxyl group of the membrane and the amino group of the low-molecular-weight amino compound. Consequently, the efficiency of restoring the membrane is increased, and it is therefore preferable.

Accordingly, it is preferable to use a low-molecular-weight amino compound having a molecular weight of several tens, e.g., about 60 to 300 and a low-molecular-weight amino compound having a molecular weight of several hundreds, e.g., about 200 to 1000 together, to use a cyclic compound and a chain compound together, or to use a straight-chain compound and a branched compound together.

Examples of the preferred combination include a combination of a diaminobenzoic acid and NMDA or aminopentane, a combination of arginine and aspartame, and a combination of aniline and MODA.

The content of the low-molecular-weight amino compound in the amino treatment water varies depending on the degree of degradation of a membrane, but an excessively high content may cause insolubilization during the alkali treatment to considerably reduce the permeation flux, and an excessively low content causes insufficient restoration. Accordingly, the concentration of the low-molecular-weight amino compound (in the case of using two or more low-molecular-weight amino compounds, the total concentration) in the amino treatment water is preferably about 1 to 1000 mg/L and particularly preferably about 5 to 500 mg/L.

In the case of using two or more low-molecular-weight amino compounds, if the concentrations of the low-molecular-weight amino compounds are highly different from each other, it is difficult to obtain the effect by using them together. Accordingly, it is preferable that the content of the low-molecular-weight amino compound contained in the lowest amount is not less than 50% of the content of the low-molecular-weight amino compound contained in the highest amount.

In the amino treatment step, these low-molecular-weight amino compounds are allowed to pass through a permeable membrane under acidic conditions exhibiting a pH of 7 or less, preferably a pH of 5.5 or less, or as an aqueous solution having an isoelectric point not higher than that of the permeable membrane to be treated.

If the pH of this amino treatment water is high, the unexpected solubility of the low-molecular-weight amino compound decreases to cause adhesion of the compound to the raw water side (primary side) of a permeable membrane, resulting in a difficulty in permeation of the compound in the permeable membrane. However, if the pH of the amino treatment water is excessively low, a large amount of an acid and a large amount of an alkali for shifting the step to the alkali treatment step are necessary, and also degradation of the membrane may be enhanced. Accordingly, the pH of the amino treatment water is preferably 1.5 or more.

Accordingly, the pH of the amino treatment water is optionally adjusted by addition of an acid. In this case, the acid used is not particularly limited, and examples thereof include inorganic acids such as hydrochloric acid, sulfuric acid, and sulfamic acid; organic acids having sulfone groups such as methanesulfonic acid; organic acids having carboxyl groups such as citric acid, malic acid, and oxalic acid; and phosphoric acid compounds such as phosphonic acid and phosphine acid. Among them, hydrochloric acid and sulfuric acid are preferred from the viewpoints of stability of solution and cost.

In such an amino treatment step, the amino treatment water may contain an inorganic electrolyte such as salt (NaCl), a neutral organic material such as isopropyl alcohol or glucose, or a low-molecular-weight polymer such as polymaleic acid, as a tracer. By doing so, the degree of restoration of a membrane can be confirmed in the amino treatment step by analyzing the degree of permeation of the salt or glucose into the water passing through the permeable membrane.

In addition, the amino treatment water may contain, in addition to the low-molecular-weight amino compound, an organic compound having a low molecular weight of 1000 or less such as an alcohol compound or a compound having a carboxyl group or sulfonic acid group, specifically, isobutanol, salicylic acid, or an isothiazoline compound in a concentration that does not cause polymerization or aggregation with the low-molecular-weight amino compound, for example, in a concentration of about 0.1 to 100 mg/L. By doing so, it is expected to increase the steric hindrance in the skin layer to enhance the effect of filling holes.

Furthermore, if the water supply pressure for allowing the amino treatment water to pass through a permeable membrane is excessively high, a problem of enhancing adsorption to a portion that is not degraded occurs. However, in an excessively low pressure, adsorption does not progress even to a degraded portion. Accordingly, the pressure is preferably 30 to 150%, particularly preferably 50 to 130%, of the pressure in normal operation of the permeable membrane.

The amino treatment step can be performed at ordinary temperature, for example, at about 10 to 35° C. The treatment time is not particularly limited as long as that the low-molecular-weight amino compound sufficiently permeates in a permeable membrane to come in contact with a degraded portion of the membrane or that in the case of a low-molecular-weight amino compound having a sufficiently low molecular weight to easily pass through a permeable membrane, the low-molecular-weight amino compound is detected in the permeated water. The treatment time does not have upper limit, but is usually 0.5 to 100 hours and particularly preferably about 1 to 50 hours.

### [Alkali Treatment Step]

After the amino treatment step, water having a pH higher than that of the amino treatment water, that is, alkali water having a pH of higher than 7 (hereinafter, referred to as “alkali treatment water”) is allowed to pass through the permeable membrane. By doing so, the solubility of the low-molecular-weight amino compound remaining in the permeable membrane decreases, and a reaction between the carboxyl group of the membrane and the amino group of the low-molecular-weight amino compound progresses to precipitate an insoluble salt of the low-molecular-weight amino compound in the membrane, resulting in restoration of the degraded portion of the membrane. If the pH of this alkali treatment water shifts to the acidic side, a sufficient precipitation effect of the low-molecular-weight amino compound is not obtained, but if the pH is too high, the membrane is degraded by the alkali. Accordingly, the pH of the alkali treatment water is preferably 7 or more and 12 or less, in particular, 11 or less.

The alkali treatment water is preferably amino treatment water containing an alkali, but may be pure water adjusted to a predetermined alkalinity by adding an alkali thereto. As in the amino treatment water, such water may also contain a tracer such as salt or glucose in the above-described concentration. Furthermore, in the case where the amino treatment step is performed simultaneously with an anion treatment step, a nonion treatment step, or a cation treatment step described below, the anion treatment step, the nonion treatment step, or the cation treatment step may be performed simultaneously with the alkali treatment step.

The alkali agent used for preparing the alkali treatment water is not particularly limited, and examples thereof include sodium hydroxide and potassium hydroxide, and sodium hydroxide is preferred from the viewpoints of cost and handling.

Furthermore, the alkali treatment water may contain a scale dispersant, for example, a phosphoric acid compound or a phosphonic acid compound at about 1 to 100 mg/L. This can prevent calcium carbonate scale or silica scale from precipitating in a system after an increase in pH.

The water supply pressure for allowing the alkali treatment water to pass through a permeable membrane is preferably 30 to 150%, in particular, 50 to 130%, of the pressure in normal operation of the permeable membrane by the same reasons as in the amino treatment step.

The alkali treatment step can be performed at ordinary temperature, for example, at about 10 to 35° C. The treatment time is not particularly limited as long as the pH of the permeated water is increased to a level near that of the alkali treatment water and, in particular, does not have upper limit, but is usually 0.5 to 100 hours and particularly preferably about 1 to 50 hours.

### [Pure Water Washing]

Pure water washing is a step optionally performed and is performed after the alkali treatment step or after the anion treatment step, the nonion treatment step, or the cation treatment step described below by allowing pure water to pass through the permeable membrane for about 0.25 to 2 hours.

The temperature and the water supply pressure in this step are similar to those in the amino treatment step and the alkali treatment step.

### [Anion Treatment Step]

The anion treatment step may be performed in the above-described amino treatment step by adding a compound having an anionic functional group to the amino treatment water, but is preferably performed after the amino treatment step and is more preferably performed after the alkali treatment step as an independent step.

This anion treatment step has an effect of fixing an amino compound or a cationic compound and can thereby fix the low-molecular-weight amino compound to a portion to be restored. Examples of the compound having an anionic functional group used in the anion treatment step include sulfonic acid group- or carboxylic acid group-containing compounds having a molecular weight of about 1000 to 10000000, such as sodium polystyrene sulfonate, alkylbenzenesulfonic acid, acrylic acid polymers, carboxylic acid polymers, and acrylic acid/maleic acid copolymers. These may be used alone or in a combination of two or more thereof.

Preferred is a combination of an acrylic acid/maleic acid copolymer having a molecular weight of 100000 or less, for example, 1000 to 100000, sodium polystyrene sulfonate, sodium alkylbenzenesulfonate (branched type), having a molecular weight of 100000 or more, for example, 200000 to 10000000. The use of this combination can achieve effects of filling gaps in high-molecular-weight polymers with a low-molecular-weight polymer and of stably adsorbing of the high-molecular-weight polymers by adsorption at multiple points.

Such a compound having an anionic functional group is preferably dissolved in water at a concentration of 1000 mg/L or less, for example, 1 to 100 mg/L and is allowed to pass through a permeable membrane. If the concentration of the compound having an anionic functional group is too low, a sufficient effect of fixing the low-molecular-weight amino compound is not obtained, but a too high concentration leads to a decrease in permeation flux.

In the combination of an acrylic acid/maleic acid copolymer having a molecular weight of 100000 or less, for example, 1000 to 100000, sodium polystyrene sulfonate, sodium alkylbenzenesulfonate (branched type), having a molecular weight of 100000 or more, for example, 200000 to 10000000, the concentration of each compound is preferably 100 mg/L or less, for example, about 5 to 50 mg/L.

Furthermore, in this anion treatment step, an aromatic carboxylic acid having a carboxyl group and a benzene skeleton such as benzoic acid, a dicarboxylic acid such as oxalic acid or citric acid, and a tricarboxylic acid may be used alone or in combination to neutralize the residual cations after restoration.

In this anion treatment step, the water for dissolving the compound having an anionic functional group may be pure water and may also contain a tracer such as salt or glucose in the above-described concentration as in the amino treatment water.

The pH of the water dissolving the compound having an anionic functional group used in the anion treatment step is usually about 5 to 10, but may be in an acidic range of about 3 to 5.

Furthermore, in the anion treatment step, a high-molecular-weight compound having a polyalkylene glycol chain such as polyethylene glycol or polyoxyalkyl stearyl ether having a molecular weight of about 2000 to 6000 or a compound having a cyclic skeleton such as cyclodextrin may be used together. By doing so, rejection is increased, and an effect of inhibiting adsorption of a charged material by absorbing the charge on the surface is achieved. In this case, in order to obtain the effects while inhibiting a reduction in permeation flux, the amount of these compounds to be added is preferably 0.1 to 100 mg/L, in particular, about 0.5 to 20 mg/L, as the concentration in water that passes through a permeable membrane in the anion treatment step.

The water supply pressure in the anion treatment step is also preferably 30 to 150%, in particular, 50 to 130%, of the pressure in normal operation of the permeable membrane by the same reasons as in the amino treatment step.

The anion treatment step can be performed at ordinary temperature, for example, at about 10 to 35° C. The treatment time is not particularly limited, in particular, does not have upper limit, but is usually 0.5 to 100 hours and particularly preferably about 1 to 50 hours.

### [Nonion Treatment Step]

The nonion treatment step may be preferably performed in the above-described amino treatment step or the alkali treatment step by adding a compound having a nonionic functional group to the amino treatment water.

Alternatively, the nonion treatment step may be performed as an independent step after the amino treatment step, or when the alkali treatment step is performed, after the alkali treatment step.

This nonion treatment step can fix a low-molecular-weight amino compound to a portion to be restored by an effect of filling holes through adsorption to a portion not highly influenced by charge. Examples of the compound having a nonionic functional group used in the nonion treatment step include alcohol fatty acid esters such as glycerin/fatty acid esters and sorbitan/fatty acid esters; polyethylene oxide polymerization adducts such as Pluronic surfactants including polyoxyalkylene esters of fatty acids, polyoxyalkylene ethers of higher alcohols, polyoxyalkylene ethers of alkylphenols, polyoxyalkylene ethers of sorbitan esters, and polyoxyalkylene ethers of polyoxypropylenes; surfactants such as alkylol amide surfactants; and hydroxyl group- or ether group-containing compounds having a molecular weight of about 100 to 10000 such as glycol compounds including polyethylene glycol, tetraethylene glycol, and polyalkylene glycol. These may be used alone or in a combination of two or more thereof.

Such a compound having a nonionic functional group is preferably dissolved in water at a concentration of 1000 mg/L or less, for example, 0.1 to 100 mg/L, in particular, 0.5 to 20 mg/L and is allowed to pass through a permeable membrane. If the concentration of the compound having a nonionic functional group is too low, a sufficient effect of fixing the low-molecular-weight amino compound is not obtained, but a too high concentration leads to a decrease in permeation flux.

In this nonion treatment step, the water for dissolving the compound having a nonionic functional group may be pure water and may also contain a tracer such as salt or glucose in the above-described concentration as in the amino treatment water. The water dissolving the compound having a nonionic functional group used in the nonion treatment step may further contain a compound having a cyclic skeleton, such as cyclodextrin, at a concentration of 0.1 to 100 mg/L, in particular, about 0.5 to 70 mg/L.

The pH of the water dissolving the compound having a nonionic functional group used in the nonion treatment step is usually about 5 to 10, but may be in an acidic range of about 3 to 5.

The water supply pressure in the nonion treatment step is also preferably 30 to 150%, in particular, 50 to 130%, of the pressure in normal operation of the permeable membrane by the same reasons as in the amino treatment step.

The nonion treatment step can be performed at ordinary temperature, for example, at about 10 to 35° C. The treatment time is not particularly limited, in particular, does not have upper limit, but is usually 0.5 to 100 hours and particularly preferably about 1 to 50 hours.

### [Cation Treatment Step]

The cation treatment step may be preferably performed in the above-described amino treatment step or the alkali treatment step by adding a compound having a cationic functional group to the amino treatment water.

Alternatively, the cation treatment step may be performed as an independent step after the amino treatment step, or when the alkali treatment step is performed, after the alkali treatment step.

This cation treatment step can fix a low-molecular-weight amino compound to a portion to be restored by an effect of closing a largely degraded portion of a membrane through binding of the cationic functional group to the carboxyl group on the membrane surface. Examples of the compound having a cationic functional group used in the cation treatment step include compounds having a primary to quaternary ammonium group or an N-containing heterocyclic group, such as benzethonium chloride, polyvinylamidine, polyethylene imine, and chitosan, and having a molecular weight of about 100 to 10000000. Particularly preferred are polymer compounds having a molecular weight of about 1000 to 10000000. These may be used alone or in a combination of two or more thereof.

Such a compound having a cationic functional group is preferably dissolved in water at a concentration of 1000 mg/L or less, for example, 1 to 1000 mg/L, in particular, 5 to 500 mg/L and is allowed to pass through a permeable membrane. If the concentration of the compound having a cationic functional group is too low, a sufficient effect of fixing the low-molecular-weight amino compound is not obtained, but a too high concentration leads to a decrease in permeation flux.

In this cation treatment step, the water for dissolving the compound having a cationic functional group may be pure water and may also contain a tracer such as salt or glucose in the above-described concentration as in the amino treatment water.

The pH of the water dissolving the compound having a cationic functional group used in the cation treatment step is usually about 5 to 10, but may be in an acidic range of about 3 to 5.

The water supply pressure in the cation treatment step is also preferably 30 to 150%, in particular, 50 to 130%, of the pressure in normal operation of the permeable membrane by the same reasons as in the amino treatment step.

The cation treatment step can be performed at ordinary temperature, for example, at about 10 to 35° C. The treatment time is not particularly limited, in particular, does not have upper limit, but is usually 0.5 to 100 hours and particularly preferably about 1 to 50 hours.

### [Permeable Membrane]

The method of improving the rejection of a permeable membrane of the present invention is suitably applied to a selective permeable membrane such as a nano filter membrane or an RO membrane. The nano filter membrane is a liquid separation film that blocks particles having a particle diameter of about 2 nm and polymers. The nano filter membrane has a membrane structure of, for example, a polymer membrane such as an asymmetry membrane, a composite membrane, or a charged membrane. The RO membrane is a liquid separation membrane that blocks a solute and permeates a solvent by applying a pressure higher than an osmotic pressure difference between solutions having the membrane therebetween to the higher concentration side. The RO membrane has a membrane structure of, for example, a polymer membrane such as an asymmetric membrane or a composite membrane. Examples of the material for the nano filter membrane or the RO membrane to which the method of improving the rejection of a permeable membrane of the present invention is applied include polyamide materials such as aromatic polyamides, aliphatic polyamides, and composite materials thereof; and cellulose materials such as cellulose acetate. Among them, the method of improving the rejection of a permeable membrane of the present invention can be particularly suitably applied to permeable membranes of aromatic polyamide materials that have a large number of carboxyl groups by breaking of C—N bonds due to degradation.

The module system of the permeable membrane to which the method of improving the rejection of a permeable membrane of the present invention is applied is not particularly limited, and examples thereof include tubular membrane modules, planar membrane modules, spiral membrane modules, and hollow-fiber membrane modules.

The permeable membrane of the present invention is such a permeable membrane, specifically, a selective permeable membrane such as an RO membrane or a nano filter membrane, applied with a rejection improving treatment by the method of improving the rejection of a permeable membrane of the present invention. The rejection is improved in the state that the permeation flux of the permeable membrane is maintained high, and the high permeation flux can be also maintained for a long time.

### [Water-Treating Method]

In the water-treating method of the present invention by a permeable membrane treatment in which water to be treated is allowed to pass through a permeable membrane of the present invention, the rejection is improved in the state that the permeable membrane has a high permeation flux, and which can be maintained for a long time. As a result, the removing effect of objective substances to be removed, such as organic substances, is high, and stable treatment is possible for a long period of time. Operation of feeding and obtaining permeate water to be treated can be performed as in usual permeable membrane treatment. In the case of treating water containing a hardness component such as calcium or magnesium, a dispersant, a scale inhibitor, or another agent may be added to raw water.

### [Permeable Membrane Device]

A permeable membrane device provided with the permeable membrane of the present invention preferably includes a permeable membrane module for feeding water to be treated to a primary side and extracting permeated water from a secondary side and a means for supplying agents for the above-described steps, that is, a low-molecular-weight amino compound, an acid, an alkali, and other compounds, to the primary side of the module. This permeable membrane module includes a pressure resisting vessel and a permeable membrane disposed so as to partition the pressure resisting vessel into the primary side and the secondary side.

This permeable membrane device is effectively applied to water treatment for collecting and reusing high- or low-concentration TOC-containing wastewater that is discharged in an electronic device manufacturing field, a semiconductor manufacturing field, and other various industrial fields; ultrapure water production from industrial water or city water; and water treatment in other fields. The water to be treated as an object is not particularly limited, but the permeable membrane device can be suitably used for organic substance-containing water, for example, treatment of organic substance-containing water having a TOC of 0.01 to 100 mg/L, preferably about 0.1 to 30 mg/L. Examples of such organic substance-containing water include, but not limited to, electronic device manufacturing industrial wastewater, transport equipment manufacturing industrial wastewater, organic synthesis industrial wastewater, printing platemaking/painting industrial wastewater, and primary wastewater thereof.

### [Water-Treating Apparatus]

The water-treating apparatus equipped with the permeable membrane of the present invention preferably includes an activated carbon filter, a coagulation/precipitation device, a coagulation flotation device, a filtration device, or a decarboxylation device, as a pretreatment unit of the permeable membrane device, in order to prevent clogging and fouling of the permeable membrane, in particular, an RO membrane. As the filtration device, for example, a sand separator, an ultrafiltration device, or a microfiltration device can be used. The pretreatment unit may further include a prefilter. Since the RO membrane is readily oxidatively degraded, it is preferable to dispose a device for removing the oxidizing agent (oxidative degradation inducer) optionally contained in raw water. As the device for removing such oxidative degradation inducers, for example, an activated carbon filter or a reducing agent injector can be used. In particular, the activated carbon filter can also remove organic substances and, therefore, can be also used as a fouling preventing means as described above. The pH of raw water is not particularly limited, but in the case of raw water containing a hardness component, it is preferable to take measures, for example, adjustment of pH to an acidic range of 5 to 7 or to use of a dispersant.

Furthermore, in the case of producing ultrapure water by this water-treating apparatus, the water-treating apparatus is provided with, for example, a decarboxylation means, an ion exchanger, an electrodeionization device, an ultraviolet oxidation device, a mix bed ion exchange resin device, or an ultrafiltration device in the subsequent stage of the permeable membrane device.

### EXAMPLES

The present invention will be more specifically described with reference to Examples and Comparative Examples below.

### [Restoration Experiment A (Examples 1 to 3 and Comparative Examples 1 to 4)]

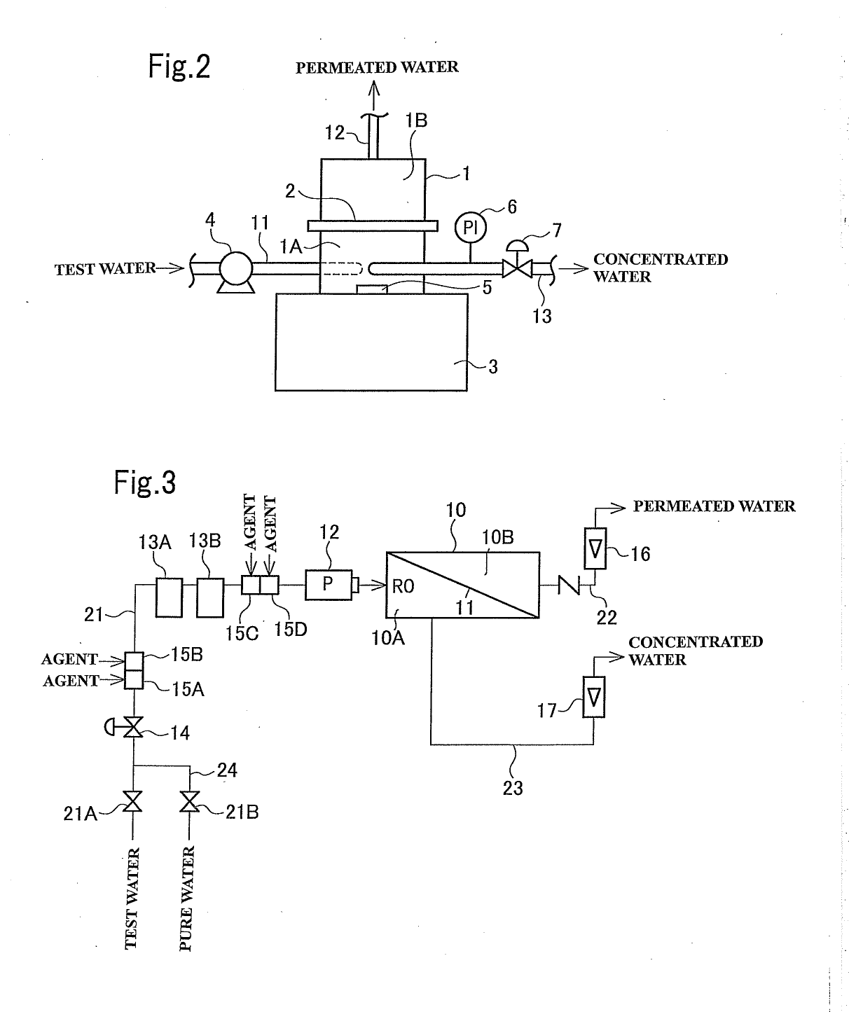

An aromatic polyamide RO membrane (normal operation pressure: 0.75 MPa) having a salt rejection (electric conductance rejection of an aqueous solution containing 2000 mg/L of NaCl) of 99.2% and a permeation flux of 1.22 m³/(m²·d) as the initial performance was used in an actual water treatment plant for about two years to obtain an oxidatively degraded flat membrane having a salt rejection of 89.3% and a permeation flux of 1.48 m³/(m²·d). This flat membrane was mounted as a sample on a flat membrane testing device shown in FIG. 2, and the restoration experiment of the membrane was performed.

In this restoration experiment A, an aqueous solution containing 2000 mg/L of NaCl was used as test water.

In this flat membrane testing device, a flat membrane disposing portion 2 is provided at a medium position in the height direction of a cylindrical container 1 having a bottom and a lid to partition the container into a raw water chamber 1A and a permeated water chamber 1B, and this container 1 is disposed on a stirrer 3. A pump 4 feeds water to be treated to the raw water chamber 1A through a pipe 11. The inside of the raw water chamber 1A is stirred by rotating a stirring bar 5 in the container 1, permeated water is extracted from the permeated water chamber 1B through a pipe 12, while concentrated water is extracted from the raw water chamber 1A through a pipe 13. The pipe 13 for extracting concentrated water is equipped with a pressure gauge 6 and an opening and closing valve 7.

Treatment procedures in Examples 1 to 3 and Comparative Examples 1 to 4 were each as follows. Incidentally, the pH of test water below was optionally adjusted by adding an acid (HCl) or an alkali (NaOH) to the test water. The passing through of water was performed at an average temperature of 25° C. and an operation pressure of 0.75 MPa.

### Example 1

Amino treatment water was prepared by adding 5 mg/L of 3,5-diaminobenzoic acid, 5 mg/L of aminopentane, and 10 mg/L of polyvinylamidine (molecular weight: 3500000) to test water (an aqueous solution containing 2000 mg/L of NaCl) and adjusting the pH to 6. This amino treatment water was fed to the flat membrane testing device, and the device was operated under this condition for two days. Subsequently, ultrapure water was fed for washing, and then the test water was fed to the flat membrane testing device.

### Example 2

Amino treatment water was prepared by adding 5 mg/L of 3,5-diaminobenzoic acid and 5 mg/L of aminopentane to test water (an aqueous solution containing 2000 mg/L of NaCl) and adjusting the pH to 6. This amino treatment water was fed to the flat membrane testing device, and the device was operated under this condition for two days. Subsequently, ultrapure water was fed for washing, and then the test water was fed to the flat membrane testing device.

### Example 3

Amino treatment water was prepared by adding 10 mg/L of 3,5-diaminobenzoic acid to test water (an aqueous solution containing 2000 mg/L of NaCl) and adjusting the pH to 6. This amino treatment water was fed to the flat membrane testing device, and the device was operated under this condition for two days. Subsequently, ultrapure water was fed for washing, and then the test water was fed to the flat membrane testing device.

### Comparative Example 1

Membrane restoration treatment water was prepared by adding 20 mg/L of an alkylamide amine derivative to test water (an aqueous solution containing 2000 mg/L of NaCl) and adjusting the pH to 6. This membrane restoration treatment water was fed to the flat membrane testing device, and the device was operated under this condition for two days. Subsequently, ultrapure water was fed for washing, and then the test water was fed to the flat membrane testing device.

### Comparative Example 2

Membrane restoration treatment water was prepared by adding 20 mg/L of cetyltrimethyl ammonium chloride to test water (an aqueous solution containing 2000 mg/L of NaCl) and adjusting the pH to 6. This membrane restoration treatment water was fed to the flat membrane testing device, and the device was operated under this condition for two days. Subsequently, ultrapure water was fed for washing, and then the test water was fed to the flat membrane testing device.

### Comparative Example 3

Membrane restoration treatment water was prepared by adding 20 mg/L of polyoxyethylene alkyl ether to test water (an aqueous solution containing 2000 mg/L of NaCl) and adjusting the pH to 6. This membrane restoration treatment water was fed to the flat membrane testing device, and the device was operated under this condition for two days. Subsequently, ultrapure water was fed for washing, and then the test water was fed to the flat membrane testing device.

### Comparative Example 4

Membrane restoration treatment water was prepared by adding 20 mg/L of polyvinylamidine to test water (an aqueous solution containing 2000 mg/L of NaCl) and adjusting the pH to 6. This membrane restoration treatment water was fed to the flat membrane testing device, and the device was operated under this condition for two days. Subsequently, ultrapure water was fed for washing, and then the test water was fed to the flat membrane testing device.

Permeation fluxes and salt rejections of the RO membrane at the start of feeding of the amino treatment water or the membrane restoration treatment water in Examples 1 to 3 and Comparative Examples 1 to 4 and after the treatment (immediately after the start of feeding of test water) and the decreasing rates of the permeation fluxes and the improvement rates of the salt rejections were investigated. The results are shown in Table 1.

Incidentally, the salt rejection was determined by measuring electric conductivity of test water (an aqueous solution containing 2000 mg/L of NaCl) fed to the flat membrane testing device with a conductance meter and calculating by the following expression:

salt rejection=(1−(electric conductivity of permeated water·2)/(electric conductivity of fed water(test water)+electric conductivity of concentrated water))·100.

The permeation flux was calculated by the following expression:

[permeated water amount]·[reference membrane surface effective pressure]/[membrane surface effective pressure]·[temperature conversion factor].

The decreasing rate of permeation flux was calculated by the following expression:

(initial permeation flux−permeation flux after treatment)/initial permeation flux·100.

The improvement rate in the salt rejection was calculated by the following expression:

{1−(initial salt rejection−salt rejection after treatment)/(initial salt rejection−salt rejection at starting)}·100.

In this restoration experiment A, the module type and the water feeding conditions in the flat membrane testing device used were different from those in the actual plant using a degraded membrane. Accordingly, a new flat membrane of the same type as the degraded membrane was mounted on the testing device shown in FIG. 2, and initial values were investigated by measuring the permeation flux and the salt rejection of this new flat membrane. The results were that the permeation flux was 0.85 m³/(m²·d) and the salt rejection was 99.1%, and these values were used as initial permeation flux and initial salt rejection in restoration experiment A.

TABLE 1

| | Permeation flux | | Decreasing | Salt rejection rate | | |
|---|---|---|---|---|---|---|
| | (m³/(m² · d) | | rate of | (%) | | Improvement |
| | | after | permeation | | after | rate of salt |
| | at starting | treatment | flux (%) | at starting | treatment | rejection (%) |
| Example 1 | 1.19 | 0.82 | 3.5 | 88.1 | 96.1 | 72.7 |
| Example 2 | 1.20 | 0.83 | 2.4 | 88.4 | 95.4 | 65.4 |
| Example 3 | 1.19 | 0.81 | 4.7 | 89.2 | 94.5 | 53.5 |
| Comparative | 1.23 | 0.26 | 69.4 | 93.6 | 97.7 | 74.5 |
| Example 1 | | | | | | |
| Comparative | 1.19 | 0.23 | 72.9 | 89.3 | 97.8 | 86.7 |
| Example 2 | | | | | | |
| Comparative | 1.22 | 0.70 | 17.6 | 90.4 | 92.4 | 23.0 |
| Example 3 | | | | | | |
| Comparative | 1.20 | 0.95 | −11.8 | 88.3 | 92.8 | 39.8 |
| Example 4 | | | | | | |

The following is obvious from Table 1.

In Example 1, the salt rejection was improved from 88.1% up to 96.1% by treatment. The decreasing rate of permeation flux in this case was about 3.5%. In Example 2, the salt rejection was improved from 88.4% up to 95.4%. The decreasing rate of permeation flux in this case was about 2.4%. In Example 3, the decreasing rate of permeation flux was about 4.7%, and the salt rejection was recovered up to 94.5%. In Example 3, only one type of a low-molecular-weight amino compound was used, and the effect was therefore slightly lower than those in Examples 1 and 2.

In any case, the decreasing rate of permeation flux was 10% or less, and the improvement rate was 50% or more. The solute concentration of treated water was not higher than 50% of that at starting.

On the other hand, in Comparative Examples 1 and 2 using cationic surfactants instead of low-molecular-weight amino compounds, though the improvement rates of the salt rejection after treatment were 74.5% and 86.7%, respectively, to show improvement, the decreasing rates of permeation flux were 69.4% and 72.9%, respectively, to show significant decrease.

In Comparative Example 3 using a nonionic surfactant instead of low-molecular-weight amino compounds, though the decreasing rate of the permeation flux was retained to 17.6%, the improvement rate of the salt rejection was merely 23.0%.

In Comparative Example 4 using a cationic polymer instead of low-molecular-weight amino compounds, though the permeation flux was higher than the initial permeation flux, the improvement rate of the salt rejection was 39.8%.

The results above reveal that the present invention can inhibit a decrease in permeation flux and can effectively improve the salt rejection.

### [Restoration Experiment B (Examples 4 to 9 and Comparative Examples 5 and 6)]

An aromatic polyamide low-pressure RO membrane module (low-pressure RO membrane “BW30-4040” 4-inch, manufactured by The Dow Chemical Company, normal operation pressure: 1.5 MPa) showing the initial performance when an aqueous solution (pH 6.7) containing 200 mg/L of NaCl and 100 mg/L of D-glucose is fed, a permeation flux of 1.17 m³/(m²·d), a salt rejection of 98.3%, and a D-glucose concentration in permeated water of less than 1 mg/L, was degraded by feeding water containing sodium hypochlorite and iron. The degradation of the membrane was performed while controlling the free effective chlorine concentration. The performance of the degraded membrane at pH 6.7 deteriorated to a permeation flux of 1.88 m³/(m²·d), a salt rejection of 68%, and a D-glucose concentration in permeated water of 37 mg/L. This degraded membrane was mounted on a 4-inch module testing device shown in FIG. 3, and the restoration experiment was performed.

In this restoration experiment B, an aqueous solution (pH 6.7) containing 200 mg/L of NaCl and 100 mg/L of D-glucose was used as test water.

In this 4-inch module testing device, the degraded membrane 11 was mounted on an RO membrane element 10 to partition it into a raw water chamber 10A and a permeated water chamber 10B, raw water is fed with a high-pressure pump 12 through a pipe 21 equipped with cartridge filters 13A and 13B, permeated water is extracted from a pipe 22, and concentrated water is extracted from a pipe 23.

The pipe 21 is connected to a pipe 24 for feeding pure water and is equipped with a motor-operated valve 14. Furthermore, the pipe 21 is provided with agent-pouring points 15A, 15B, 15C, and 15D, and a necessary agent can be poured at each point. The pipes 22 and 23 are equipped with flowmeters 16 and 17, respectively.

Treatment procedures in Examples 4 to 9 and Comparative Examples 4 and 5 were each as follows. Incidentally, the pH of test water was optionally adjusted below by adding an acid (HCl) or an alkali (NaOH) to the test water. The passing through of water was performed at an average temperature of 25° C. and an operation pressure of 1.5 MPa.

### Example 4

Amino treatment water was prepared by adding 5 mg/L of 3,5-diaminobenzoic acid, 5 mg/L of aminopentane, and 10 mg/L of polyvinylamidine (molecular weight: 3500000) to test water (an aqueous solution (pH 6.7) containing 200 mg/L of NaCl and 100 mg/L of D-glucose) and adjusting the pH to 5 to 5.5. This amino treatment water was passed through the module testing device for 2 hours. Subsequently, alkali treatment water containing the same amounts of 3,5-diaminobenzoic acid, aminopentane, and polyvinylamidine as those in the test water but the pH of which was adjusted to 7.5 was passed through the module testing device for 2 hours. Furthermore, passing through of pure water was performed for washing, and then feeding of test water was started, followed by operation for 4 hours.

### Example 5

The passing through of water having a pH of 5 to 5.5, water having a pH of 7.5, and pure water for washing in Example 4 were repeated twice (passing through of water of pH 5 to 5.5-3 passing through of water of pH 7.5→pure water washing→passing through of water of pH 5 to 5.5→passing through of water of pH 7.5→pure water washing), and then feeding of test water was started, followed by operation for 4 hours.

### Example 6

Treatment was performed as in Example 4 except that the pH condition in passing through of water of pH 5 to 5.5 was changed to pH 6.

### Example 7

Treatment was performed as in Example 4 except that the pH condition in passing through of water of pH 5 to 5.5 was changed to pH 4 and then the pH condition in passing through of water of pH 7.5 was changed to pH 10.

### Example 8

Amino treatment water was prepared by adding 5 mg/L of 3,5-diaminobenzoic acid to test water (an aqueous solution (pH 6.7) containing 200 mg/L of NaCl and 100 mg/L of D-glucose) and adjusting the pH to 5 to 5.5. This amino treatment water was passed through the module testing device for 2 hours. Subsequently, passing through of pure water was performed for washing, and then feeding of test water was started, followed by operation for 4 hours.

### Example 9

Amino treatment water was prepared by adding 5 mg/L of 2-methyloctanediamine (MODA) to test water (an aqueous solution (pH 6.7) containing 200 mg/L of NaCl and 100 mg/L of D-glucose) and adjusting the pH to 5 to 5.5. This amino treatment water was passed through the module testing device for 2 hours. Subsequently, passing through of pure water was performed for washing, and then feeding of test water was started, followed by operation for 4 hours.

### Comparative Example 5

Membrane restoration treatment water was prepared by adding 20 mg/L of cetyltrimethyl ammonium chloride to test water (an aqueous solution (pH 6.7) containing 200 mg/L of NaCl and 100 mg/L of D-glucose) and adjusting the pH to 5 to 5.5. Passing through of this membrane restoration treatment water was performed for 2 hours. Subsequently, passing through of pure water was performed for washing, and then feeding of test water was started, followed by operation for 4 hours.

### Comparative Example 6

Membrane restoration treatment water was prepared by adding 20 mg/L of polyoxyethylene alkyl ether to test water (an aqueous solution (pH 6.7) containing 200 mg/L of NaCl and 100 mg/L of D-glucose) and adjusting the pH to 5 to 5.5. Passing through of this membrane restoration treatment water was performed for 2 hours. Subsequently, passing through of pure water was performed for washing, and then feeding of test water was started, followed by operation for 4 hours.

Permeation fluxes and salt rejections before and after the treatment in Examples 4 to 9 and Comparative Examples 5 and 6 and D-glucose concentration in permeated water were investigated. The results are shown in Table 2.

Incidentally, the salt rejection was determined by measuring electric conductivity with a conductance meter and calculating by the following expression:

salt rejection=(1−(electric conductivity of permeated water·2)/(electric conductivity of fed water(test water)+electric conductivity of concentrated water))·100.

The D-glucose concentration was measured with an RQflex10 analyzer manufactured by Merck & Co., Inc.

The permeation flux was calculated by the following expression:

[permeated water amount]·[reference membrane surface effective pressure]/[membrane surface effective pressure]·[temperature conversion factor].

In Table 2, “after treatment” means “after passing through of test water for 4 hours”.

TABLE 2

| | | | | | D-Glucose | |
|---|---|---|---|---|---|---|
| | Permeation | | | | concentration in | |
| | flux | | Salt rejection | | permeated water | |
| | (m³/(m² · d) | | (%) | | (mg/L) | |
| | | after | | after | before | |
| | before | treat- | before | treat- | treat- | after |
| | treatment | ment | treatment | ment | ment | treatment |
| Example 4 | 1.88 | 1.81 | 68.0 | 91.1 | 37 | 3 |
| Example 5 | 1.90 | 1.79 | 68.8 | 95.9 | 38 | 2 |
| Example 6 | 1.87 | 1.83 | 67.4 | 87.3 | 38 | 5 |
| Example 7 | 1.88 | 1.76 | 69.0 | 95.8 | 37 | 2 |
| Example 8 | 1.89 | 1.85 | 67.0 | 72.8 | 35 | 10 |
| Example 9 | 1.87 | 1.83 | 66.8 | 74.2 | 36 | 11 |
| Comparative | 1.89 | 0.36 | 69.3 | 97.8 | 36 | 1 |
| Example 5 | | | | | | |
| Comparative | 1.88 | 1.68 | 71.0 | 73.2 | 39 | 18 |
| Example 6 | | | | | | |

The following is obvious from Table 2.

The salt rejection was recovered by 23.1% (91.1−68.0=23.1) in Example 4 and by 27.1% (95.9−68.8=27.1) in Example 5. The D-glucose concentration in permeated water decreased from 37 mg/L to 3 mg/L in Example 4 and from 38 mg/L to 2 mg/L in Example 5. In these cases, the permeation flux did not significantly decrease. In also Examples 6 and 7, similar satisfactory results were obtained.

On the other hand, in Comparative Example 5, though the salt rejection was recovered by 28.5% (97.8−69.3=28.5), the permeation flux largely decreased from 1.89 m³/(m²·d) to 0.36 m³/(m²·d). In Comparative Example 6, the operation was stopped on the stage before a large reduction in permeation flux, but a large improvement in the salt rejection was not recognized.

In Examples 8 and 9, though the salt rejections were recovered by 18.3% (85.3−67.0=18.3) and 23.5% (90.3−66.8=23.5), the D-glucose concentration in permeated water did not decrease to 10 mg/L or less. Thus, it was confirmed that the restoration effect in the case of using one type of amino compound is low.

[Restoration experiment C (Examples 10 to 14)]

As in restoration experiment B, an aromatic polyamide low-pressure RO membrane module (low-pressure RO membrane “BW30-4040” 4-inch, manufactured by The Dow Chemical Company, normal operation pressure: 1.5 MPa) showing the initial performance when an aqueous solution (pH 6.7) containing 200 mg/L of NaCl and 100 mg/L of D-glucose is fed, a permeation flux of 1.17 m³/(m²·d), a salt rejection of 98.3%, and a D-glucose concentration in permeated water of less than 1 mg/L, was degraded by sodium hypochlorite and iron. The membrane of which performance at pH 6.7 deteriorated to a permeation flux of 1.88 m³/(m²·d), a salt rejection of 68%, and a D-glucose concentration in permeated water of 37 mg/L was used as a sample in the restoration experiment with the 4-inch module testing device shown in FIG. 3.

In this restoration experiment C, an aqueous solution (pH 6.7) containing 200 mg/L of NaCl and 100 mg/L of D-glucose was used as test water.

Treatment procedures in Examples 10 to 14 were each as follows. Incidentally, the pH of test water was optionally adjusted below by adding an acid (HCl) or an alkali (NaOH) to the test water. The passing through of water was performed at an average temperature of 25° C. and an operation pressure of 1.5 MPa.

### Example 10

Amino treatment water was prepared by adding 5 mg/L of 3,5-diaminobenzoic acid, 5 mg/L of aminopentane, and 10 mg/L of polyvinylamidine (molecular weight: 3500000) to test water (an aqueous solution (pH 6.7) containing 200 mg/L of NaCl and 100 mg/L of D-glucose) and adjusting the pH to 5 to 5.5. This amino treatment water was passed through the module testing device for 2 hours. Subsequently, alkali treatment water containing the same amounts of 3,5-diaminobenzoic acid, aminopentane, and polyvinylamidine as those in the test water but the pH of which was adjusted to 7.5 was passed through the module testing device for 2 hours. Furthermore, passing through of pure water was performed for washing, and then anion treatment water prepared by adding 100 mg/L of an anionic compound (branched alkylbenzenesulfonic acid, molecular weight: 350) to the test water and adjusting the pH to 6 to 8 was passed through the module testing device for 4 hours. Furthermore, passing through of pure water was performed for washing, and then feeding of test water was started, followed by operation for 5 hours.

### Example 11

Treatment was performed as in Example 10 except that nonion treatment was performed using an aqueous solution containing 20 mg/L of a nonionic compound (PEG, molecular weight: 3000) instead of the anion treatment using the aqueous solution of an anionic compound.

### Example 12

Treatment was performed as in Example 10 except that an aqueous solution containing 10 mg/L of a nonionic compound (PEG, molecular weight: 3000) was used together with 50 mg/L of an anionic compound.

### Example 13

Treatment was performed as in Example 10 except that nonion treatment was performed using an aqueous solution containing 10 mg/L of polyethylene glycol (molecular weight: 3000) and 50 mg/L of cyclodextrin instead of the anion treatment by the aqueous solution of an anionic compound.

### Example 14

Treatment was performed as in Example 10 except that anion treatment was not performed.

Permeation fluxes and salt rejections before and after the treatment in Examples 10 to 14 were investigated as in restoration experiment B. The results are shown in Table 3.

Incidentally, in Table 3, “immediately after treatment” refers to “immediately after starting of feeding of test water after passing through washing with pure water, and “5 days after treatment” refers to “after operation for 5 days from the starting of feeding of test water after passing through washing with pure water”.

TABLE 3

| | | | Immediately | | 5 days | |
|---|---|---|---|---|---|---|
| | Before treatment | | after treatment | | after treatment | |
| | | Salt | | Salt | | Salt |
| | Permeation flux | rejection | Permeation flux | rejection | Permeation flux | rejection |
| | (m³/(m² · d) | (%) | (m³/(m² · d) | (%) | (m³/(m² · d) | (%) |
| Example 10 | 1.88 | 68.0 | 1.81 | 91.1 | 1.83 | 88.8 |
| Example 11 | 1.90 | 68.8 | 1.70 | 95.9 | 1.81 | 90.1 |
| Example 12 | 1.88 | 68.0 | 1.81 | 91.1 | 1.81 | 90.6 |
| Example 13 | 1.87 | 68.3 | 1.77 | 94.3 | 1.78 | 90.4 |
| Example 14 | 1.86 | 69.5 | 1.81 | 92.2 | 1.84 | 85.2 |

The following is obvious from Table 3.

In Example 14, though the salt rejection of 69.5% before treatment was improved to 92.2% immediately after treatment, the salt rejection deteriorated to 85.2% by detachment of the adhering compound by continuously passing through of water for 5 days.

In contrast, in Examples 10 to 13, the salt rejections of 68.0% to 68.8% before treatment were recovered to 91.1% to 95.9% immediately after treatment and were maintained at 88.8% to 90.6% even after continuous passing through of water for 5 days by conditioning of membrane surface (fixing of the adhering amino compound) with an anionic surfactant or a nonionic surfactant.

### [Restoration Experiment D (Examples 15 to 17 and Comparative Example 7)]

As in restoration experiment B, an aromatic polyamide low-pressure RO membrane module (low-pressure RO membrane “BW30-4040” 4-inch, manufactured by The Dow Chemical Company, normal operation pressure: 1.5 MPa) showing the initial performance when an aqueous solution (pH 6.7) containing 200 mg/L of NaCl and 100 mg/L of D-glucose is fed, a permeation flux of 1.17 m³/(m²·d), a salt rejection of 98.3%, and a D-glucose concentration in permeated water of less than 1 mg/L, was degraded by sodium hypochlorite and iron. The membrane of which performance at pH 6.7 deteriorated to a permeation flux of 1.88 m³/(m²·d), a salt rejection of 68%, and a D-glucose concentration in permeated water of 37 mg/L was used as a sample in the restoration experiment with the 4-inch module testing device shown in FIG. 3.

In this restoration experiment D, an aqueous solution (pH 6.7) containing 200 mg/L of NaCl and 100 mg/L of D-glucose was used as test water.

Treatment procedures in Examples 15 to 17 and Comparative Example 7 were each as follows. Incidentally, the pH of test water was optionally adjusted below by adding an acid (HCl) or an alkali (NaOH) to the test water. In any experiment, the passing through of water was performed at an average temperature of 25° C. and an operation pressure of 1.5 MPa, and chitosan prepared in the following production example was used.

### <Production Example of Chitosan>

A hundred grams of chitosan 5 (manufactured by Wako Pure Chemicals Industries, Ltd., 0 to 10 mPa·s) was dissolved in 400 g of an aqueous solution of 30% by weight of hydrochloric acid. The resulting solution was heated at 80° C. for hydrolysis and then was cooled to 0° C. to 5° C., followed by leaving to stand for 24 hours. The heating time at 80° C. was varied in a range of 5 to 60 min to obtain aqueous solutions containing chitosan (concentration: 20% by weight) having different average molecular weights. The weight-average molecular weights of the resulting chitosan measured by GPC were 500, 750, 1000, and 1250. These were diluted and were respectively used as chitosan 500, chitosan 750, chitosan 1000, and chitosan 1250 in the following Examples and Comparative Example.

### Example 15

A solution was prepared by adding 5 mg/L of chitosan 500, 5 mg/L of aminopentane, and 10 mg/L of polyvinylamidine (molecular weight: 3500000) to test water (an aqueous solution (pH 6.7) containing 200 mg/L of NaCl and 100 mg/L of D-glucose) and adjusting the pH to 5 to 5.5, and passing through of this solution was performed for 2 hours. Subsequently, a solution containing the same amounts of chitosan 500, aminopentane, and polyvinylamidine as those in the test water but the pH of which was adjusted to 7.5 was passed through the device for 2 hours. Furthermore, passing through of pure water was performed for washing, and then feeding of test water was started, followed by operation for 4 hours.

### Example 16

Treatment was performed as in Example 15 except that chitosan 750 was used instead of chitosan 500.

### Example 17

Treatment was performed as in Example 15 except that chitosan 1000 was used instead of chitosan 500.

### Example 18

Treatment was performed as in Example 15 except that chitosan 1250 was used instead of chitosan 500.

Permeation fluxes and salt rejections before and after the treatment in Examples and Comparative Example and D-glucose concentration in permeated water were investigated. The results are shown in Table 4.

Incidentally, the salt rejection was determined by measuring electric conductivity with a conductance meter and calculating by the following expression:

salt rejection=(1−(electric conductivity of permeated water·2)/(electric conductivity of fed water(test water)+electric conductivity of concentrated water))·100.

The D-glucose concentration was measured with an RQflex10 analyzer manufactured by Merck & Co., Inc.

The permeation flux was calculated by the following expression:

[permeated water amount]·[reference membrane surface effective pressure]/[membrane surface effective pressure]·[temperature conversion factor].

In Table 4, “after treatment” means “after pure water washing and passing through of test water for 4 hours”.

### Example 19

Treatment was performed as in Example 16 except that aminopentane was not used.

### Example 20

Treatment was performed as in Example 17 except that aminopentane was not used.

### Comparative Example 7

Treatment was performed as in Example 18 except that aminopentane was not used.

TABLE 4

| | | | | | D-Glucose | |
|---|---|---|---|---|---|---|
| | Permeation | | | | concentration in | |
| | flux | | Salt rejection | | permeated water | |
| | (m³/(m² · d) | | (%) | | (mg/L) | |
| | | after | | after | before | |
| | before | treat- | before | treat- | treat- | after |
| | treatment | ment | treatment | ment | ment | treatment |
| Example 15 | 1.87 | 1.80 | 68.2 | 91.0 | 37 | 3 |
| Example 16 | 1.89 | 1.83 | 67.9 | 89.7 | 38 | 5 |
| Example 17 | 1.88 | 1.84 | 68.1 | 88.2 | 37 | 7 |
| Example 18 | 1.89 | 1.88 | 67.9 | 79.8 | 38 | 10 |
| Example 19 | 1.88 | 1.86 | 68.0 | 78.8 | 38 | 10 |
| Example 20 | 1.87 | 1.86 | 67.9 | 77.5 | 37 | 13 |
| Comparative | 1.89 | 1.88 | 68.0 | 70.2 | 38 | 32 |
| Example 7 | | | | | | |

The following is obvious from Table 4.

There was a tendency that the permeation flux after treatment increased with an increase in molecular weight of the amino group-containing compound used in the amino treatment step, while the salt rejection after treatment decreased. In particular, as the restoration experiment varying only the molecular weight of chitosan under conditions not using aminopentane, the results of comparison of Example 20 using chitosan having a molecular weight of 1000 and Comparative Example 7 using chitosan having a molecular weight of 1250 were that the salt rejection of the former was recovered to 77.5%, approximately 80%, after treatment, whereas that of the latter was recovered to merely 70.2%, approximately 70%.

### [Restoration Experiment E (Examples 21 to 28)]

A degraded membrane was prepared by oxidatively degrading ultra-low-pressure membrane ES-20 manufactured by Nitto Denko Corporation with hydrogen peroxide and iron. The initial performance of this membrane, a salt rejection (electric conductance rejection) of 99%, an IPA rejection of 88% (test water: an aqueous solution containing 500 mg/L of NaCl and 100 mg/L of IPA), and a permeation flux of 0.85 m³/(m²·d), were changed after oxidative degradation to, a salt rejection of 82%, an IPA rejection of 60%, and a permeation flux of 1.3 m³/(m²·d). Incidentally, the evaluation of performance and the restoration experiment were performed using the flat membrane testing device used in restoration experiment A. In any experiment, the passing through of water was performed at an average temperature of 25° C. and an operation pressure of 0.75 MPa.

### Example 21

As an amino treatment step, an aqueous solution prepared by adding 10 mg/L of arginine to test water (an aqueous solution containing 500 mg/L of NaCl and 100 mg/L of IPA) and adjusting the pH to 5 was fed to the flat membrane testing device, followed by operation for 2 hours. Subsequently, as an alkali treatment step, an aqueous solution prepared by adding 10 mg/L of arginine to test water and adjusting the pH to 8 was fed to the flat membrane testing device, followed by operation for 2 hours. Furthermore, passing through of pure water was performed for washing, and then feeding of test water was started, followed by operation for 4 hours.

### Example 22

As an amino treatment step, an aqueous solution prepared by adding 10 mg/L of arginine and 1 mg/L of polyvinylamidine to test water and adjusting the pH to 5 was fed to the flat membrane testing device, followed by operation for 2 hours. Subsequently, as an alkali treatment step, an aqueous solution prepared by adding 10 mg/L of arginine and 1 mg/L of polyvinylamidine to test water and adjusting the pH to 8 was fed to the flat membrane testing device, followed by operation for 2 hours. Furthermore, passing through of pure water was performed for washing, and then feeding of test water was started, followed by operation for 4 hours.

### Example 23

As an amino treatment step, an aqueous solution prepared by adding 10 mg/L of arginine and 1 mg/L of polyvinylamidine to test water and adjusting the pH to 5 was fed to the flat membrane testing device, followed by operation for 2 hours. Subsequently, as an alkali treatment step, an aqueous solution prepared by adding 10 mg/L of arginine and 1 mg/L of polyvinylamidine to test water and adjusting the pH to 8 was fed to the flat membrane testing device, followed by operation for 2 hours. After passing through of pure water for 1 hour, as an anion treatment step, an aqueous solution prepared by adding an aqueous solution of sodium polystyrenesulfonate having a molecular weight of 1000000 to test water and adjusting the pH to 6.5 was fed to the flat membrane testing device, followed by operation for 2 hours. Furthermore, passing through of pure water was performed for washing, and then feeding of test water was started, followed by operation for 4 hours.

### Example 24

As an amino treatment step, an aqueous solution prepared by adding 10 mg/L of arginine to test water (an aqueous solution containing 500 mg/L of NaCl and 100 mg/L of IPA) and adjusting the pH to 5 was fed to the flat membrane testing device, followed by operation for 2 hours. Subsequently, as an alkali treatment step, an aqueous solution prepared by adding 10 mg/L of arginine to test water and adjusting the pH to 8 was fed to the flat membrane testing device, followed by operation for 2 hours. After passing through of pure water for 1 hour, as an anion treatment step, an aqueous solution prepared by adding 1 mg/L of oxalic acid to test water was fed to the flat membrane testing device, followed by operation for 20 hours. Furthermore, passing through of pure water was performed for washing, and then feeding of test water was started, followed by operation for 4 hours.

### Example 25

As an amino treatment step, an aqueous solution prepared by adding 10 mg/L of arginine to test water (an aqueous solution containing 500 mg/L of NaCl and 100 mg/L of IPA) and adjusting the pH to 5 was fed to the flat membrane testing device, followed by operation for 2 hours. Subsequently, as an alkali treatment step, an aqueous solution prepared by adding 10 mg/L of arginine to test water and adjusting the pH to 8 was fed to the flat membrane testing device, followed by operation for 2 hours. After passing through of pure water for 1 hour, as an anion treatment step, an aqueous solution prepared by adding 1 mg/L of oxalic acid to test water was fed to the flat membrane testing device, followed by operation for 20 hours. After passing through of pure water for 1 hour, as a cation treatment step, an aqueous solution prepared by adding 1 mg/L of polyvinylamidine to test water and adjusting the pH to 6 was fed to the flat membrane testing device, followed by operation for 2 hours. After passing through of pure water for 1 hour, as an anion treatment step, an aqueous solution prepared by adding an aqueous solution of sodium polystyrenesulfonate having a molecular weight of 1000000 to test water and adjusting the pH to 6.5 was fed to the flat membrane testing device, followed by operation for 2 hours. Furthermore, passing through of pure water was performed for washing, and then feeding of test water was started, followed by operation for 4 hours.

### Example 26

As an amino treatment step, an aqueous solution prepared by adding 5 mg/L of arginine and 5 mg/L of aspartame to test water (an aqueous solution containing 500 mg/L of NaCl and 100 mg/L of IPA) and adjusting the pH to 5 was fed to the flat membrane testing device, followed by operation for 2 hours. Subsequently, as an alkali treatment step, an aqueous solution prepared by adding 5 mg/L of arginine and 5 mg/L of aspartame to test water and adjusting the pH to 8 was fed to the flat membrane testing device, followed by operation for 2 hours. After passing through of pure water for 1 hour, as an anion treatment step, an aqueous solution prepared by adding 1 mg/L of oxalic acid to test water was fed to the flat membrane testing device, followed by operation for 20 hours. After passing through of pure water for 1 hour, as a cation treatment step, an aqueous solution prepared by adding 1 mg/L of polyvinylamidine to test water and adjusting the pH to 6 was fed to the flat membrane testing device, followed by operation for 2 hours. After passing through of pure water for 1 hour, as an anion treatment step, an aqueous solution prepared by adding an aqueous solution of sodium polystyrenesulfonate having a molecular weight of 1000000 to test water and adjusting the pH to 6.5 was fed to the flat membrane testing device, followed by operation for 2 hours. Furthermore, passing through of pure water was performed for washing, and then feeding of test water was started, followed by operation for 4 hours.

### Example 27

As an amino treatment step, an aqueous solution prepared by adding 10 mg/L of phenylalanine and 1 mg/L of polyvinylamidine to test water and adjusting the pH to 5 was fed to the flat membrane testing device, followed by operation for 2 hours. Subsequently, as an alkali treatment step, an aqueous solution prepared by adding 10 mg/L of arginine and 1 mg/L of polyvinylamidine to test water and adjusting the pH to 8 was fed to the flat membrane testing device, followed by operation for 2 hours. After passing through of pure water for 1 hour, as an anion treatment step, an aqueous solution prepared by adding an aqueous solution of sodium polystyrenesulfonate having a molecular weight of 1000000 to test water and adjusting the pH to 6.5 was fed to the flat membrane testing device, followed by operation for 2 hours. Furthermore, passing through of pure water was performed for washing, and then feeding of test water was started, followed by operation for 4 hours.

### Example 28

As an amino treatment step, an aqueous solution prepared by adding 10 mg/L of glycine and 1 mg/L of polyvinylamidine to test water and adjusting the pH to 5 was fed to the flat membrane testing device, followed by operation for 2 hours. Subsequently, as an alkali treatment step, an aqueous solution prepared by adding 10 mg/L of arginine and 1 mg/L of polyvinylamidine to test water and adjusting the pH to 8 was fed to the flat membrane testing device, followed by operation for 2 hours. After passing through of pure water for 1 hour, as an anion treatment step, an aqueous solution prepared by adding an aqueous solution of sodium polystyrenesulfonate having a molecular weight of 1000000 to test water and adjusting the pH to 6.5 was fed to the flat membrane testing device, followed by operation for 2 hours. Furthermore, passing through of pure water was performed for washing, and then feeding of test water was started, followed by operation for 4 hours.

The permeation fluxes, the salt rejections, and the IPA rejections before and after treatment in restoration experiment E are shown in Table 5.

TABLE 5

| | Permeation | | | | IPA | |
|---|---|---|---|---|---|---|
| | flux | | Salt rejection | | rejection | |
| | (m³/(m² · d) | | (%) | | (%) | |
| | | after | | after | before | |
| | before | treat- | before | treat- | treat- | after |
| | treatment | ment | treatment | ment | ment | treatment |
| Example 21 | 1.30 | 1.04 | 82.1 | 88.4 | 60.1 | 71.3 |
| Example 22 | 1.31 | 0.90 | 81.9 | 89.7 | 59.9 | 73.8 |
| Example 23 | 1.29 | 0.87 | 82.2 | 94.4 | 60.3 | 75.2 |
| Example 24 | 1.30 | 0.96 | 82.0 | 91.1 | 60.2 | 78.6 |
| Example 25 | 1.31 | 0.83 | 81.8 | 96.2 | 59.9 | 80.4 |
| Example 26 | 1.32 | 0.80 | 81.8 | 98.5 | 59.8 | 84.1 |
| Example 27 | 1.30 | 0.85 | 82.0 | 93.8 | 60.1 | 76.1 |
| Example 28 | 1.31 | 0.92 | 81.9 | 90.6 | 60.0 | 73.5 |

The following is obvious from Table 5.

The rejection could be recovered without largely decreasing permeation flux even when arginine, aspartame, phenylalanine, or glycine was used as the low-molecular-weight amino compound in the amino treatment step.

While the present invention has been described in detail with its specific embodiments, it is apparent to those skilled in the art that various modifications can be made without departing from the spirit and scope of the invention.

This application is based on Japanese Patent Application (Japanese Patent Application No. 2009-224643) filed Sep. 29, 2009, the contents of which are hereby incorporated by reference.

1. A method of improving a rejection of a permeable membrane, the method comprising a step of passing an aqueous solution having a pH of 7 or less and containing an amino group-containing compound having a molecular weight of 1000 or less (hereinafter, this aqueous solution is referred to as “amino treatment water”) through the permeable membrane.

2. The method of improving the rejection of a permeable membrane according to claim 1, wherein the method further comprises an alkali treatment step of passing a second aqueous solution having a pH of higher than 7 through the permeable membrane after the amino treatment step.

3. The method of improving the rejection of a permeable membrane according to claim 2, wherein the second aqueous solution contains an amino group-containing compound having a molecular weight of 1000 or less.

4. The method of improving the rejection of a permeable membrane according to claim 1, wherein an aqueous solution containing a compound having an anionic functional group is allowed to pass through the permeable membrane in the amino treatment step or after the amino treatment step.

5. The method of improving the rejection of a permeable membrane according to claim 1, wherein an aqueous solution containing a compound having a nonionic functional group and/or a compound having a cationic functional group is allowed to pass through the permeable membrane in the amino treatment step or after the amino treatment step.

6. The method of improving the rejection of a permeable membrane according to claim 1, wherein the amino treatment water further contains a compound having a cationic functional group.

7. The method of improving the rejection of a permeable membrane according to claim 3, wherein the second aqueous solution used in the alkali treatment step further contains a compound having a cationic functional group.

8. The method of improving the rejection of a permeable membrane according to claim 6, wherein the compound having a cationic functional group is polyvinylamidine.

9. The method of improving the rejection of a permeable membrane according to claim 2, the method further comprising, after the alkali treatment step, passing a third aqueous solution containing at least one of a compound having an anionic functional group and a compound having a nonionic functional group through the permeable membrane.

10. The method of improving the rejection of a permeable membrane according to claim 2, wherein the amino treatment step and the alkali treatment step are repeated twice or more.

11. The method of improving the rejection of a permeable membrane according to claim 1, wherein the amino group-containing compound having a molecular weight of 1000 or less is at least one selected from the group consisting of aromatic amino compounds, aromatic aminocarboxylic acid compounds, aliphatic amino compounds, aliphatic aminoalcohols, heterocyclic amino compounds, and amino acid compounds.

12. The method of improving the rejection of a permeable membrane according to claim 1, wherein the amino group-containing compound having a molecular weight of 1000 or less includes an aromatic aminocarboxylic acid compound and an aliphatic amino compound.

13. The method of improving the rejection of a permeable membrane according to claim 11, wherein the aromatic aminocarboxylic acid compound is diaminobenzoic acid or triaminobenzoic acid.

14. The method of improving the rejection of a permeable membrane according to claim 11, wherein the heterocyclic amino compound is chitosan.

15. The method of improving the rejection of a permeable membrane according to claim 11, wherein the aliphatic amino compound includes a hydrocarbon group having 1 to 20 carbon atoms.

16. The method of improving the rejection of a permeable membrane according to claim 15, wherein the aliphatic amino compound is aminopentane or 2-methyloctanediamine.

17. The method of improving the rejection of a permeable membrane according to claim 4, wherein the compound having an anionic functional group is a sulfonic acid group- or carboxylic acid group-containing compound having a molecular weight of 1000 to 10000000.

18. The method of improving the rejection of a permeable membrane according to claim 4, wherein the compound having an anionic functional group is at least one selected from the group consisting of sodium polystyrenesulfonate, alkylbenzenesulfonic acid, acrylic acid polymers, carboxylic acid polymers, and acrylic acid/maleic acid copolymers.

19. The method of improving the rejection of a permeable membrane according to claim 9, wherein the compound having an anionic functional group is at least one selected from the group consisting of sodium polystyrenesulfonate, alkylbenzenesulfonic acid, acrylic acid polymers, carboxylic acid polymers, and acrylic acid/maleic acid copolymers.

20. The method of improving the rejection of a permeable membrane according to claim 9, wherein the compound having a nonionic functional group is a glycol compound having a molecular weight of 100 to 1000.

21. The method of improving the rejection of a permeable membrane according to claim 9, wherein the compound having an anionic functional group is an alkylbenzenesulfonic acid and the compound having a nonionic functional group is a polyethylene glycol compound.

22. The method of improving the rejection of a permeable membrane according to claim 9, wherein the third aqueous solution further contains cyclodextrin.

23. A permeable membrane subjected to rejection-improving treatment by the method of improving the rejection of a permeable membrane according to claim 1.
